(19) United States
(12) Patent Application Publication
(10) Pub. No.: US 2025/0067633 A1
(43) Pub. Date: Feb. 27, 2025

(54) SURFACE SAMPLING DEVICE AND METHODS

(71) Applicant: Institute for Environmental Health, Inc., Lake Forest Park, WA (US)

(72) Inventor: Mansour SAMADPOUR, Lake Forest Park, WA (US)

(21) Appl. No.: 18/726,369

(22) PCT Filed: Feb. 3, 2023
(86) PCT No.: PCT/US2023/061914

§ 371 Date: Jul. 2, 2024

Related U.S. Application Data
(60) Provisional application No. 63/307,601, filed on Feb. 7, 2022.

(51) Int. Cl. G01N 1/08

(52) U.S. Cl. CPC G01N 1/08

(57) ABSTRACT

Disclosed are devices and methods using same for taking surface samples of bulk materials or loose materials for testing purposes (e.g., presence of pathogens, microorganisms, contaminants, etc.) in a manner that improves efficiency, reliability, repeatability, and case of use. The methods and devices provide for protecting the sample from accidental outside contamination by providing for immediate placement of collected pieces of material into a protected sampling container or collection space. The methods and devices require less hand-eye coordination skill than using a knife, and are thus more easily used by workers and/or by robots to achieve consistent results.

### CROSS-REFERENCE TO RELATED APPLICATION

The application claims the benefit of priority to U.S. Provisional Patent Application Ser. No. 63/307,601, filed Feb. 7, 2022, which is hereby incorporated by reference in its entirety.

### FIELD OF THE INVENTION

Aspects of the present invention relate generally to devices and methods for taking surface samples of bulk materials or loose materials for testing purposes, and in more particular aspects to devices and methods for testing surfaces for the presence of pathogens, microorganisms, or contaminants, etc., in a manner that improves efficiency, reliability, repeatability of results, and ease of use.

### BACKGROUND

Surface sampling is performed in a variety of industries to test for potential pathogens, microorganisms, or contaminants introduced to surfaces during prior processing steps or incoming bulk or loose materials. Bulk or loose materials may be any material with respect to which surface sampling is desired, including but not limited to food (e.g., meat, vegetables, produce, etc.) or non-food, or any other material.

Many methods exist in the art for taking surface samples. For example, a sponge is commonly used as a device to swab surfaces in order to gather a material sample, which can be tested for the presence of pathogens, microorganisms, or contaminants. Such methods typically involve using a sterile sponge to wipe a surface, then placing the sponge into a sterile container. The sample is then analyzed to determine if particular contaminants are present. This method can yield varying results, depending on the person who is performing the sample gathering steps. For example, if one person applies more pressure to the surface than another, they have the potential to gather more material and there is a larger chance that a contamination would be sensed. Additionally, the sponge is exposed at all times to the outside environment, and if a user accidentally brushes the sponge against another surface, the sponge will gather a sample from that surface as well. Moreover, using sponges to gather multiple samples at once can lead to cross-contamination of samples and should be avoided.

Another exemplary sampling method employed in slaughterhouses involves having a worker cut a piece of meat from a carcass or bulk material by hand. This method, although reliable for collecting a discrete sample which can be combined into a larger conglomerate sample, will also yield varying results based on the performance and consistency of the worker. Additionally, the workers may gather different ratios of meat to surface area, resulting in inconsistent results. Certain areas (e.g., surfaces areas) of future food products, such as cattle carcasses, have areas which are hard to reach by hand and are awkwardly shaped when cutting off a piece by hand. For truly random sampling, workers would be required to sample cattle carcasses in all locations, which is not feasible when taking samples with hand-cut pieces. Moreover, even if the workers do manage it, it would be difficult to obtain repeatable results. Furthermore, microorganisms, pathogens, or other contaminating particles are usually concentrated in areas which are hard to clean, and therefore hard to reach by human workers during sampling processes. Workers, therefore, may not wish to risk contaminating the process by reaching into such hard-to-reach areas of the product while taking a sample. Hand samples are also laborious, take substantial time to complete, can be cross-contaminated by negligent workers, and must be taken one by one. Additionally, the samples taken by hand must be broken up before testing in order to release any microorganisms trapped in the surface structure of the material.

Most contaminants are on the surfaces of bulk products, and which may be introduced at any step during processing. The surface of the material, therefore, is the most relevant part to sample and there really is no need to take samples far below the surface. Additionally, it is advantageous to sample bulk material without first taking it apart into smaller pieces.

There is, therefore, a profound need in the art for devices and/or methods to sample multiple surfaces and combine the resulting material samples into one sample without exposure to the environment. There is a profound need in the art to provide a means to maintain sample integrity more easily, so that consistent results can be obtained by different workers. There is a profound need in the art for a device which removes all, or substantially all human interaction with the sampling event to obtain sanitary, reliable, and repeatable results. There is a profound need in the art to allow a sample to be taken in a minimally invasive method to maintain visual characteristics of the product. There is a profound need in the art to provide a method of sampling that is less labor-intensive. There is a profound need in the art to provide a method of sampling that can be used on all types and shapes of sample surfaces and maintain consistency of results, which will allow for a more random sampling. There is a profound need in the art to provide a sample which needs no further mechanical processing prior to testing. There is a profound need in the art for a reliable method of limiting depth of material removal during sampling. There is a profound need in the art for a device which can be used on surfaces at any stage.

### SUMMARY OF PARTICULAR APSECTS OF THE INVENTION

As a solution to these and other problems, certain aspects of the present invention provide easy and versatile devices and methods for surface sampling of bulk and loose materials.

Particular aspects provide a sample containing and gathering devices, which shield the gathered sample from the outside environment. The device(s) may, in each case, comprise one or more gathering surfaces having protrusions, a non-smooth surface, and/or perforations in order to break up and gather smaller pieces of the bulk material for sampling purposes. The device(s) may also be constructed of one piece or more than one piece. For example, the sample container and gathering device may comprise, or may be composed of a canister and a lid, so that the sample can easily be accessed after the gathering event. The sample containing and gathering device(s) may be configured with (e.g., may be lined with) a bag or other lining container or material, which may be sanitary and may be re-used, or may be disposable, such that as the gathering surface is used to take a material sample, the sample is directed into the sanitary liner, which may be sealed after sampling. The sample containing and gathering device(s) may be made of any combination of re-usable or disposable parts. The sample containing and gathering device(s) may have a mechanical means for attachment to an actuator of some sort, such as a pneumatic drill or a robot, and/or may have a coupler to go between the actuator and the sample container. The sample containing and gathering device(s) may be used by a human worker and/or a robot. The sample containing and gathering device(s) may be sanitized before use, or may be provided in a sanitary enclosure to ensure veracity of the results. The gathering surface of the sample containing and gathering device(s) may be brought into contact with the surface to be sampled, and pressure may be applied. The gathering surface(s) may be rotated, vibrated, scraped, or otherwise moved so that the gathering surface(s) slices off pieces of the material to be sampled. The gathering surface(s) may be shaped such that as pieces of the sampling surface are broken off, they are directed to the inside of the sample containing and gathering device(s), or are gathered by means of a vacuum or by scraping into a sanitary container. The sample containing and gathering device(s) may comprise a gathering surface or surfaces that may be configured or selected in terms of in size and shape depending on the application, and any protrusions, perforations, or surface finishes or surface shapes can be configured or selected to match the application. The gathering surface of the device(s) may be configured to take a reliable surface sample from any shape, size, or location on or of bulk material or loose material, to provide for a more random sampling.

Particular aspects provide methods for surface sampling, comprising using the sample containing and gathering devices to take a sample of a singular surface, or to sample multiple areas of a single surface or multiple surfaces. In the methods, the material from all of the samples may be combined in the sampling container of the sample containing and gathering devices. In the methods, after the sampling steps are completed, the sample (e.g., within the sampling container, or removed therefrom) may be placed in a sanitary location and/or may be fitted with a lid or other means for maintaining sample integrity until further steps are taken in the testing process. In the methods, examples of sanitary locations and/or means may include, but are not limited to, capping the gathering surface such that no sample particles can escape, and no external particles or contamination can enter, bagging the entire sample containing and gathering device, or removing a sanitary liner holding a sample from within the sampling container and sealing it to outside influence. In the methods, the gathering surface(s) of the sample containing and gathering device(s) may have a constant size, and a constant or set amount of pressure and/or a constant or set amount of time in contact with the same material and with the same motion imparted on the surface may be applied, such that consistent samples may be gathered by a robot and/or a human. In the methods, humans have the additional visual advantage of seeing the effect of material removal on the surface, so that the same amount of material can be removed during each sampling with ease. In the methods, there are fewer steps than with other sampling methods and devices in the art, thereby decreasing the chances for user error.

The methods and devices provide for protecting the sample from accidental outside contamination by providing for immediate placement of collected pieces of material into a protected sampling container. The methods and devices require less hand-eye coordination skill than using a knife, and are thus more easily used by workers and/or by robots to achieve consistent results.

Provided are sample containing and gathering devices, comprising: a sample gathering end portion having a wall with an inner surface and an outer sample gathering surface with one or more apertures communicating therebetween; a coupling end portion having a wall with an inner surface and an outer coupler surface; and a sample canister having a wall with inner and outer wall surfaces extending between and connecting with the end portions along a central axis, wherein the inner canister wall surface, and the inner surfaces of the sample gathering end portion or of the coupling end portion, or both define an inner sample-containing space, and wherein the sample gathering end portion, the coupling end portion, or both are configured to be reversibly detachable from the sample canister to provide a respective first sample canister open end, a second sample canister open end, or both, to provide access to the sample containing space. The coupling end portion may be integral with the sample canister, and not reversibly detachable. The sample gathering end portion may be integral with the sample canister, and not reversibly detachable. The sample gathering end portion may be reversibly detachable and may comprise a cylindrical cap having an open end defined by an open-end lip, an end having the sample gathering surface, and first threads configured in the wall between the sample gathering surface and the open-end lip and engageable on the inner surface of the sample gathering end portion, wherein the sample canister is cylindrical having a first open end defined by a first rim, and second threads complementary to the first threads and configured in the canister wall between the first rim and a sealing lip positioned on the outer canister wall surface to provide a seat for the open-end lip of the sample gathering end portion when attached to the sample canister. The sample gathering end portion may be reversibly detachable and may comprise a cylindrical cap having an open end defined by an open-end lip, an end having the sample gathering surface, and first threads configured in the wall between the sample gathering surface and the open-end lip and engageable on the inner surface of the sample gathering end portion, wherein the sample canister is cylindrical having a first open end defined by a first rim, and second threads complementary to the first threads and configured in the canister wall between the first rim and a sealing lip positioned on the outer canister wall surface to provide a seat for the open-end lip of the sample gathering end portion when attached to the sample canister. The coupling end portion may be reversibly detachable and may comprise a cylindrical cap having a closed end, an open end, and third threads (or first attachment members) configured therebetween in the coupling end wall and engageable on the inner surface of the coupling end portion, and wherein the sample canister has fourth threads (or second attachment members) complementary to the third threads (or first attachment members) and configured on the canister wall, and engageable on the outer canister wall surface, at a distance from the second open end sufficient to provide for reversible attachment of the coupling end portion. The coupling end portion may be reversibly detachable and may comprise a cylindrical cap having a closed end, an open end, and third threads (or first attachment members) configured therebetween in the coupling end wall and engageable on the inner surface of the coupling end portion, and wherein the sample canister has fourth threads (or second attachment members) complementary to the third threads (or first attachment members) and configured on the canister wall, and engageable on the outer canister wall surface, at a distance from the second open end sufficient to provide for reversible attachment of the coupling end portion. The sample canister may have the first and the second sample canister open ends, and both the sample gathering end portion and the coupling end portion may be configured to be reversibly detachable from the sample canister. The sample canister may have the first and the second sample canister open ends, and wherein both the sample gathering end portion and the coupling end portion may be configured to be reversibly detachable from the sample canister. The coupling end portion may be configured to provide a mechanical coupling between an actuator device and the coupling end portion. The device may further comprise a coupler member configured to provide a mechanical coupling between an actuator device and the integral coupling end portion. The coupler member may comprise a cylindrical cap having a wall with inner and outer surfaces, a closed end, an open end, and coupler threads (or first attachment members) configured in the wall between the closed and the open ends and engageable on the inner surface of the coupler member, and wherein the sample canister has canister threads (or second attachment members) complementary to the coupler threads (or first attachment members) and configured and engageable on the outer canister wall surface to provide for reversible attachment of the coupler member. Both the rim and the sealing lip of the sample canister may provide seats when the sample gathering end portion is attached to the sample canister. The sample the gathering surface may comprise one or more apertures communicating between the inner and outer sample gathering surfaces. The sample gathering surface may be flat or outwardly raised, and the one or more apertures in each case may comprise a respective cutting protrusion extending outwardly from the sample gathering surface configured, upon actuation of the device, to cut into sample material and direct the sampled material to the inside of the sample containing and gathering device. The sample gathering surface may be flat or outwardly raised, and the one or more apertures in each case may comprise one or more respective circular edges or blades defining one or more respective circular sampling holes configured, upon actuation of the device, to cut into sample material and direct the sampled material to the inside of the sample containing and gathering device.

The devices disclosed herein may comprise a bag or other lining container or material.

The device may be shown in FIGS. 17C and 17D, or in FIGS. 17E and 17F, wherein the sample gathering surface of the sample gathering end portion may be outwardly raised, may comprise a single sampling aperture defining a circular cutting edge or blade, and may be beveled (e.g., one or more beveled portions at a different angle with respect to the central axis) or domed, the single circular sampling aperture being centered around the central axis.

Additionally provided devices may be as shown in FIGS. 18A and 18B, wherein the sample gathering device comprises: a rear mounting portion 108 defining an extension axis; an axially aligned front sample cutting portion 110, having, an outer circular blade edge 109 disposed outwardly at a rearward angle relative to the extension axis; and an axially alighted back sample gathering portion, positioned between the rear mounting portion and the front sample cutting portion, having a sample gathering surface 112 with a rear margin defining a sample sizing gap between the blade edge and the rear margin, the back sample gathering portion being integral or non-integral with the rear mounting portion and/or the front sample cutting portion.

Additionally provided devices may be as shown in FIGS. 18C and 18D, wherein the sample gathering device comprises: a rear mounting portion 108 defining an extension axis; and an axially aligned front sample cutting portion 115 having an outer circular blade edge 113 disposed outwardly at a rearward angle relative to the extension axis, and an inner sample gathering surface 114 having an inner margin defining a sample sizing gap between the blade edge and the inner margin on the lower surface, the front sample cutting portion being integral or non-integral with the rear mounting portion.

Additionally provided devices may be as shown in FIGS. 18E and 18F, wherein the sample gathering device comprises: a rear mounting portion 108 defining an extension axis; an axially aligned front, sample gathering surface portion 119 having a wall with an inner surface and a raised outer sample gathering surface having a single sampling aperture communicating therebetween and defining a circular cutting edge or blade 118; and an axially aligned flange 117 having a plurality of spaced connecting arms connecting the front sample gathering surface portion and the rear mounting portion 108, the flange being integral or non-integral with the rear mounting portion and/or the front, sample gathering surface portion.

Additionally provided sample containing and gathering devices may be as shown in FIGS. 19A and 19B, wherein the push to cut device comprises: a sample gathering circular end portion 130 having a lower open end, and having an upper raised angled sampling surface 121 and 122 extending outwardly from a central axis to a sharp outer edge circular cutting blade 120; a coupling end portion having a wall with an inner surface and an outer coupler surface; and a sample canister having a wall with inner and outer wall surfaces extending between and connecting with the end portions along the central axis, wherein the inner canister wall surface, and the inner surfaces of the sample gathering end portion or of the coupling end portion, or both define an inner sample-containing space, and wherein the sample gathering end portion, the coupling end portion, or both are configured to be reversibly detachable from the sample canister to provide a respective first sample canister open end, a second sample canister open end, or both, to provide access to the sample containing space.

Yet additionally provided sample containing and gathering devices may be as shown in FIGS. 19C and 19D, wherein the push to cut device comprises: the device of claim 23, wherein the sample gathering circular end portion comprises a neck portion 125 extending inwardly toward the central axis between the lower open end and the upper raised angled sampling surface.

### BRIEF DESCRIPTION OF THE DRAWINGS

FIG. 1A shows an exemplary sampling container that is a part of a preferred embodiment of the device.

FIG. 1B shows an exemplary sample gathering surface which can be assembled onto the sampling canister of FIG. 1A as a part of a preferred embodiment of a sample containing and gathering device.

FIG. 1C shows an exemplary coupler component which may optionally be assembled onto the components shown in FIGS. 1A and 1B to provide a mechanical coupling between an actuator device and the sample containing and gathering device, and may be a part of the preferred embodiment.

FIGS. 2A and 2B show side and cross-sectional views, respectively, of the exemplary components of the preferred embodiment shown in FIGS. 1A-1C assembled.

FIGS. 3A-3F show exemplary alternative options for the sample gathering surface which can be assembled, for example, onto the preferred embodiment illustrated in FIGS. 1A and 2B in place of the component illustrated in FIG. 1B.

FIGS. 4A and 4B illustrate exemplary alternative preferred embodiments of the device where the functions of sample gathering, containing, and coupling the device to an actuator are combined into two parts which snap together.

FIGS. 5A and 5B show additional exemplary preferred embodiments with differently shaped (e.g., ovoid/parabolic, and domed, respectively) sample gathering surfaces and features (e.g., raised protrusions, and perforations (bored or punched holes/apertures), respectively) to gather samples from differently shaped or textured surfaces.

FIGS. 6A and 6B show different exemplary configurations for integrating a liner or bag into use with an exemplary preferred device embodiment (e.g., such as with the device embodiments of FIGS. 1A and 2B, or with any other suitable embodiments disclosed herein).

FIGS. 7A and 7B show an exemplary sample containing and gathering canister comprising an installed lid with a sample gathering surface. The canister has a feature (e.g., groove feature 47 visible in the sectional view of FIG. 7B) which would allow a bag to be tied onto the rim and be protected from contamination by the lid.

FIGS. 8A-8D show examples of how the present device could be supplied in a sanitary container (FIG. 8A), be removed (FIG. 8B), used to collect a sample (FIG. 8C) and re-sealed (FIG. 8D) for subsequent testing without any need to touch the sample gathering surface.

FIGS. 9A-9D show exemplary two-piece preferred device embodiments which could be used in the same manner as shown for the device illustrated in FIGS. 8A-8D to avoid contamination. The couplers of the embodiments of FIGS. 9C-9D are taller to provide an extended surface that encloses at least a portion of the collecting container surface of the collecting and gathering device, and configured such that a user could brace against the extended surface while taking a sample, without contaminating the surfaces of the of the collecting and gathering device.

FIGS. 10A and 10B show an alternative embodiment of the present device, wherein the entire sample gathering surface, or a substantial portion thereof, comprises or is made from a porous and abrasive material that provides for initial particle capture on the surface of the device, and subsequent passage of the captured particles into the interior collecting chamber of the device.

FIGS. 11A-11E show an alternative embodiment where a retractable external sheath is configured on the sample containing and gathering device such that the sheath extends beyond the sample gathering surface when the device is not in use, and is configured to be pressed back upon contact of the sheathe device with a sample surface and/or be pulled back by a user to take a sample.

FIGS. 12A and 12B show a preferred embodiment of a sample containing and gathering device, where a sanitary lid has been placed (e.g., attached) on top of the sample gathering surface after sampling to maintain sample integrity.

FIGS. 13A and 13B show an exemplary embodiment where the sample container portion of the sample containing and gathering device is made up of a tube and a bottom lid which can be unscrewed to remove the sample.

FIG. 14 shows an exemplary robotic gantry and coupling mechanism that may be used to automate the sample taking process on an assembly line. In this embodiment, the preferred embodiment of FIGS. 1A-2B is coupled onto a spindle of the robotic gantry.

FIG. 15 shows the exemplary preferred embodiment of FIGS. 1A and 2B assembled onto a commercial robot to automate the sampling process.

FIG. 16 shows the exemplary preferred embodiment of FIGS. 1A and 2B with a sample inside.

FIGS. 17A-17F show exemplary alternative options for the sample gathering surface which can be assembled, for example, onto the preferred embodiment illustrated in FIGS. 1A and 2B in place of the component illustrated in FIG. 1B.

FIGS. 18A-18F show exemplary additional sample containing and gathering device embodiments.

FIGS. 19A-19D show exemplary additional sample containing and gathering device embodiments.

### DETAILED DESCRIPTION OF THE INVENTION

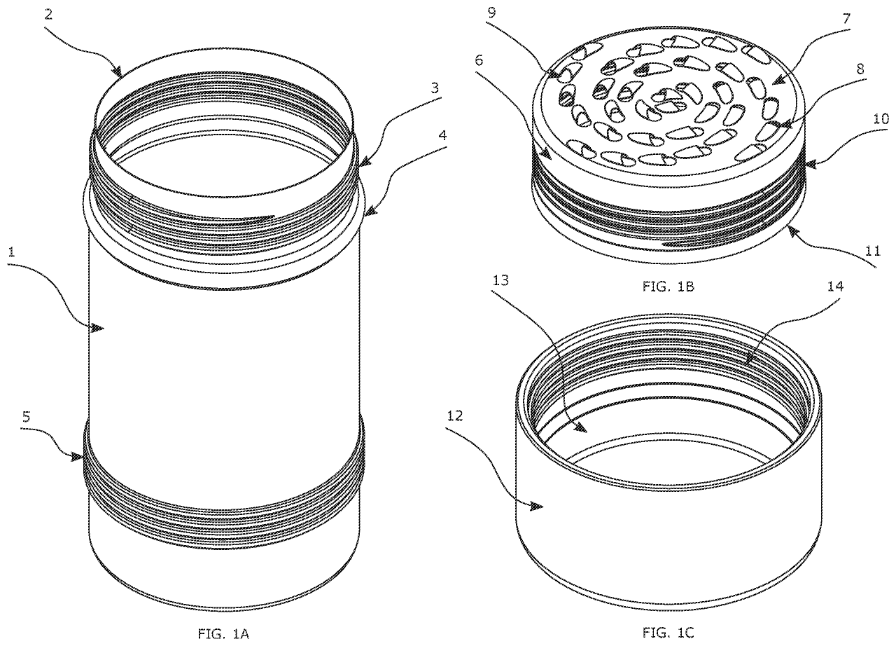

FIG. 1A shows an exemplary sample/sampling container 1 that is a part of a preferred embodiment of the device. Cylindrical sample container 1 has inner and outer surfaces, an open end with a rim 2 and threads 3 extending from the outer surface and spaced between the rim 2 and a sealing lip 4 positioned on the outer surface of the container 1 at a distance from the rim 2 sufficient to accommodate the threads 3 and provide a seat (e.g., seal) for lip 11 of a sample gathering surface/lid 6 (FIG. 1B) when mounted on the sample container 1. When the lid 6 is mounted onto the container 1, both the rim 2 and the lip 4 may provide seats (e.g., seals). The opposite end of the sample container 1 is closed and contains threads 5 extending from the outer surface of the container 1 and positioned/configured at a sufficient distance from the closed end to provide for attachment of a coupling member/device 12 (FIG. 1C), to enable use of an actuator (e.g., a robot or commercial drill) to actuate (e.g., rotate, turn, vibrate, oscillate, etc.) the sample gathering assembly (the assembled container 1 and sample gathering surface/lid 6).

FIG. 1B shows an exemplary sample gathering surface 7 which may be assembled onto the sampling canister 1 of FIG. 1A as a part of a preferred embodiment of a sample containing and gathering device. FIG. 1B shows a cylindrical sample gathering surface/lid 6 having an open end and an end having a sample gathering surface 7 with protrusion(s) 8 extending from the surface 7 and configured, upon actuation, to cut into sample material to remove small pieces. The protrusions 8 are shaped and configured with respective holes/apertures 9 through the surface 7 to direct the sampled material to the inside of the sample container 1. Sample gathering surface/lid 6 has a lip 11 and threads 10, positioned between the sample gathering surface 7 and the open end, complementary to threads 3 on container 1 to provide for reversibly assembling/attaching the sample gathering surface/lid 6 to the sample container 1, and for removal of the lid 6 for sample extraction from container 1. Threads 10 and lip 11 are positioned and configured such that, upon mounting/assembly, lip 11 is seatable on lip 4 on the sample container 1 to prevent material from passing through mated threads 3 and 10 to the inside of the container 1. Preferably, as in this embodiment, the lid 6 is configured such that threads 10 encompass/cover threads 3 of the container 1 once mounted/mated.

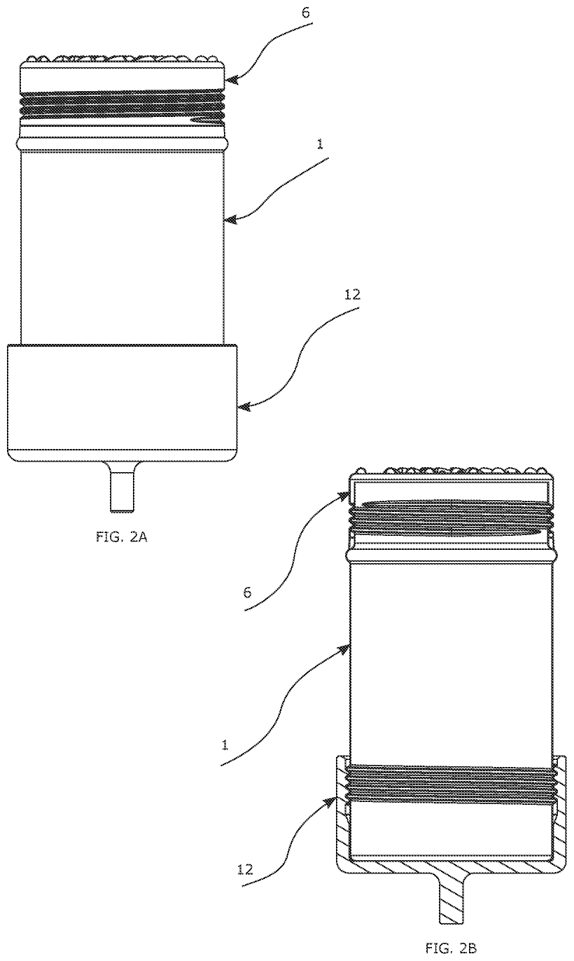

FIG. 1C shows an exemplary coupler component which may be assembled onto the components shown in FIGS. 1A and 1B to provide a mechanical coupling between an actuator device and the sample containing and gathering device, and may be a part of the preferred embodiment. FIG. 1C shows cylindrical coupling member/coupler 12 having a closed end, an open end, and threads 14 positioned on, and extending inwardly from the inside surface of the coupler 12 between the open and closed ends, and configured to be complementary to threads 5 so that the coupler can be attached/mated to the closed end of the sample container 1. Preferably, as in this embodiment, the coupler 12 is configured such that threads 14 encompass/cover threads 5 of the container 1 once mounted/mated. The coupler 12 is configured, in operation of the device, to couple sample container 1 to an actuator (e.g., a robot, commercial drill or other actuating device) to actuate (e.g., rotate, turn, vibrate, oscillate, etc.) the sample gathering assembly, and may comprise an extension or mounting member extending (e.g., axially) from the outer closed end of the actuator 12 (not visible in the view of FIG. 1C, but see FIGS. 2A and 2B) to facilitate attachment to an actuator (e.g., by means of a complementary chuck on the actuator). Preferably, as in this embodiment, the inside diameter 13 of the coupler 1 between the closed end and the threads 14 is smaller than that from between the bottoms of threads 14, and/or than at the open end of the coupler 12 to facilitate holding the sample container 1 straight (e.g., perpendicularly or co-axially with respect to the coupler 12 (e.g., see assembled device of FIG. 2B). In particular embodiments, the inside diameter 13 of the coupler 1 between the closed end and the threads 14 may be same as that from between the inward peaks of threads 14.

FIGS. 2A and 2B show side and cross-sectional views, respectively, of the assembled exemplary components of the preferred embodiment(s) shown in FIGS. 1A-1C.

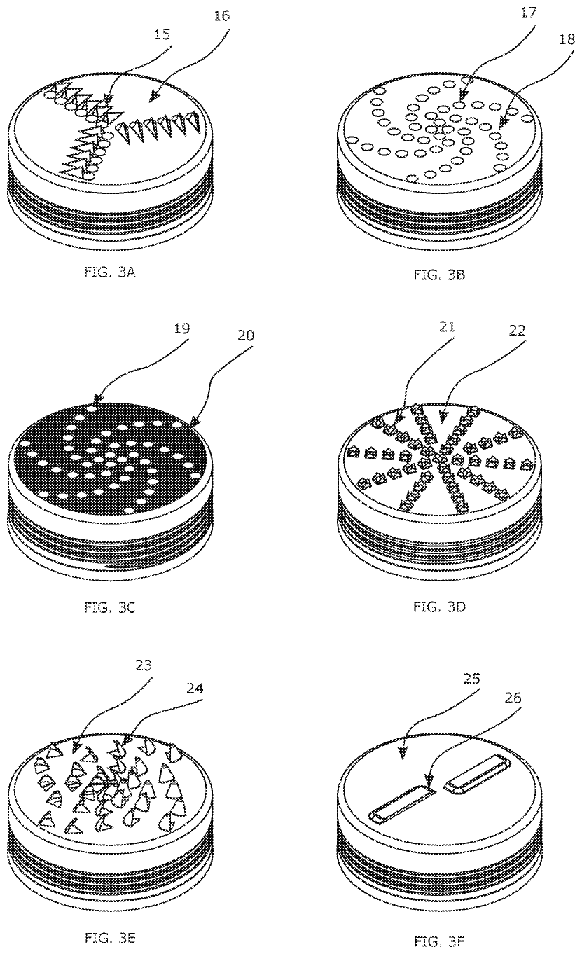

FIGS. 3A-3F show exemplary alternative options for the sample gathering surface which can be assembled onto the preferred embodiment illustrated in FIGS. 1A and 2B in place of the sample gathering surface/lid 6 and surface 7 illustrated in FIG. 1B. FIG. 3A shows a sample gathering surface 16 (in this embodiment a smooth surface) having a spoked array (in this embodiment three radial spokes) of triangular (e.g., inverted v-shaped) raised protrusions 15 configured with a respective array of apertures to direct sampled material into the sample container 1. FIG. 3B shows a sample gathering surface 18 (in this embodiment a smooth surface) having a swirled/vortical array of perforations/holes (e.g., bored or punched apertures) 17 configured to sample and direct sampled material into the container 1. Pressure between the sample gathering device and the bulk material will force the material to bulge into the apertures and be cut by the aperture edges upon actuation of the sample gathering surface 18. Preferably, such perforations/holes/apertures will have sharp edges to cut pieces of material from bulk material being sampled. FIG. 3C shows a sample gathering surface 20 having a swirled/vortical array of perforations/holes (e.g., bored or punched apertures) 19 configured to sample and direct sampled material into the container 1. Preferably, such perforations/holes/apertures 19 will have sharp edges to cut pieces of material from bulk material being sampled. In this embodiment, the sample gathering surface 20 has a rough, rather than smooth, surface texture to break up the material being sampled such that it can more easily pass through the holes 19. FIG. 3D shows a sample gathering surface 22 (in this embodiment a smooth surface) having a spoked array (in this embodiment ten radial spokes) of raised (e.g., vertically) sets of four triangular protrusions 21 defining an opening (e.g., square) through surface 22, and in this instance formed by punching through a sheet of material used to create the surface 22. FIG. 3E shows a sample gathering surface 24 (in this embodiment a smooth surface) having a swirled/vortical array of raised (e.g., angularly) triangular protrusions 23 defining an opening (e.g., triangular) through surface 24, and in this instance formed by punching through a sheet of material used to create the surface 24. FIG. 3F shows a sample gathering surface 25 (in this embodiment a smooth surface) having an array of raised elongated blades/protrusions 26 having an elongated cutting edge, and each protrusion configured with an elongated opening through surface 25. In further embodiments, the sample gathering surfaces, and including embodiments similar to the exemplary sample gathering surface embodiments described here, may have any number of protrusions (including none) and/or holes in any combination of protrusion shapes and patterns, provided there is at least one hole configured to direct sampled material into the container 1. Likewise, the surfaces of such sample gathering surfaces may be smooth and/or rough. Moreover, in taking a sample, more than one sample gathering surface design may be used in combination with a given sampling container 1, depending on the nature/configuration/properties of the material to be sampled.

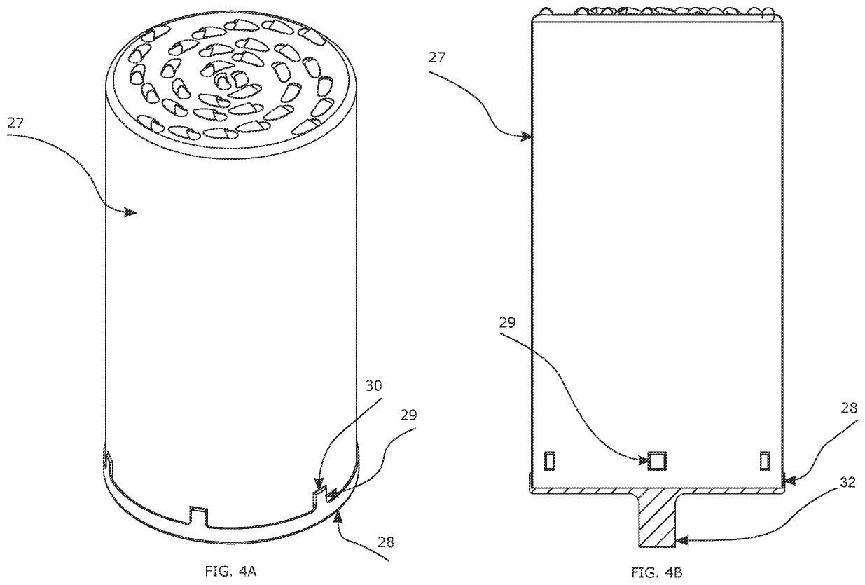

FIGS. 4A and 4B illustrate exemplary alternative preferred embodiments of the sample containing and gathering device, wherein the functions of sample gathering, containing, and coupling the device to an actuator are combined into two parts which snap together. In the embodiment of FIG. 4A, the sample gathering surface is similar to that of the lid 6 of FIG. 1B, but is rather integrated as part of the sample container 27. In this embodiment, the sample container 27 is open at the end opposite the integral sample gathering surface, and a coupler 28 provides a cover for the combined sample gathering container 27, defining a sample containing space/chamber therein. As shown in cross-section of FIG. 4B, the coupler 28 has a shaft 32 extending (e.g., axially) from its outer surface to facilitate coupling to an actuator (e.g., robot, drill, etc.). Tabs/Taps 29 configured on the coupler 28 snap into complementary apertures/holes 30 configured in the combined sampling container and surface 27 to reversibly mount the coupler 28 to the sample container 27 to transfer torque thereto. In preferred aspects, the inside surface 31 of tabs 29 are flush with the inside surface of the combined sample gathering container 27, to facilitate removal of the coupler 28. Alternatively, the outer surface of the combined sample gathering container 27 near its open end may be configured with tabs that snap into complementary apertures/holes configured in the coupler 28 to reversibly mount the coupler 28 to the combined sample gathering container 27 to transfer torque thereto. In such alternative aspects, the outside surface of tabs may be flush with the outside surface of the combined sample gathering container 27, to facilitate removal of the coupler 28.

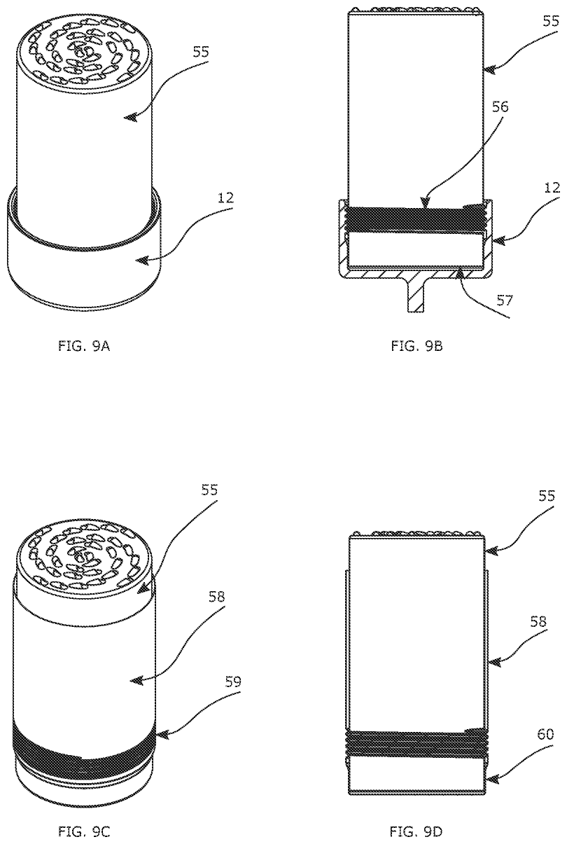

In further embodiments, the tabs 29 and complementary apertures/holes 30 may be used in the embodiments of FIGS. 1 and 2 in place of the complementary threads 14 and 5. Likewise, the threads 14 and 5 illustrated in FIGS. 1 and 2 may replace the tabs 29 and complementary holes 30 of the embodiment of FIG. 4 (e.g., as in the embodiments shown in FIGS. 9A and 9B, described herein below.

Additionally, while not shown in the exemplary embodiment of FIG. 4, the combined sample gathering container 27 may further comprise threads and/or a lip, analogous to the threads 3 and lip 4 of FIG. 1A, extending from, and positioned/configured on the outer surface of the combined sample gathering container 27 near the sample gathering surface to accommodate complementary threads of, and/or provide a seat (e.g., seal) for a removable protective/sealing cap (having no sampling surface; and also not shown here) to seal the combined sample gathering container 27 before and/or after taking of a sample. Alternatively a protective/sealing cap may be mounted/mated to cover and seal the sample gathering surface of combined sample gathering container 27 by other complementary attachment means (e.g., tabs, clips, adhesive, snap-fits (e.g., a circumferential raised ridge on the outer surface of the combined sample gathering container 27 that snap fits into a complementary circumferential ridge on the inner surface of a wall of a sealing cap), etc.).

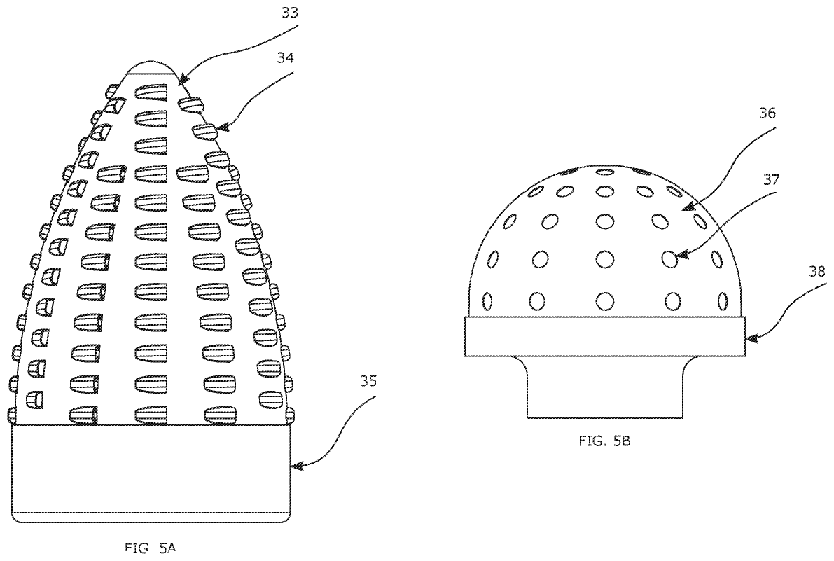

FIGS. 5A and 5B show additional exemplary preferred embodiments of combined sample gathering containers with differently shaped non-flat and non-developable sample gathering surfaces (e.g., a surface that cannot be flattened onto a plane without distortion) and sample gathering features, configured to gather samples from differently shaped or textured surfaces. FIG. 5A shows an ovoid/parabolic sample gathering surface 33 of a combined sample gathering container having arching arrays of sample gathering/cutting protrusions 34 each protrusion configured with an orifice/hole in the sample gathering surface to direct cut sample material to the interior of the combined sample gathering container. There is a coupler 35 that provides a cover for the combined sample gathering container to define a sample containing space/chamber therein, and that couples the combined sample gathering container to an actuator (not shown). While not shown in FIG. 5A, as in other coupler embodiments, the coupler 35 may have a shaft or the like, extending (e.g., axially) from its outer surface to facilitate coupling to an actuator. Additionally, while not shown in FIG. 5A, as in other coupler embodiments, the coupler 35 may be configured with threads or other attachment members (e.g., tabs, clips, snap-fits, etc.) that communicate with complementary elements on the surface of the combined sample gathering container to provide for mounting/mating with the coupler 35. FIG. 5B shows a domed sample gathering surface 36 of a combined sample gathering container having arching arrays of sample gathering/cutting holes/orifices 37 configured to be even flush with the sample gathering surface (e.g., punched out holes or other punched out shape such as ovoid, triangular square, etc.) and to cut and direct cut sample material to the interior of the combined sample gathering container. Such flush gathering/cutting orifices 37 are particularly useful for soft bulk materials where the sample can deform around a flat surface. There is a coupler 38 that provides a cover for the combined sample gathering container to define a sample containing space/chamber therein, and that couples the combined sample gathering container to an actuator (not shown). While not shown in FIG. 5B, as in other coupler embodiments, the coupler 38 may have a shaft or the like, extending (e.g., axially) from its outer surface to facilitate coupling to an actuator. Additionally, while not shown in FIG. 5B, as in other coupler embodiments, the coupler 38 may be configured with threads or other attachment members (e.g., tabs, clips, snap-fits, etc.) that communicate with complementary elements on the surface of the combined sample gathering container to provide for mounting/mating with the coupler 38.

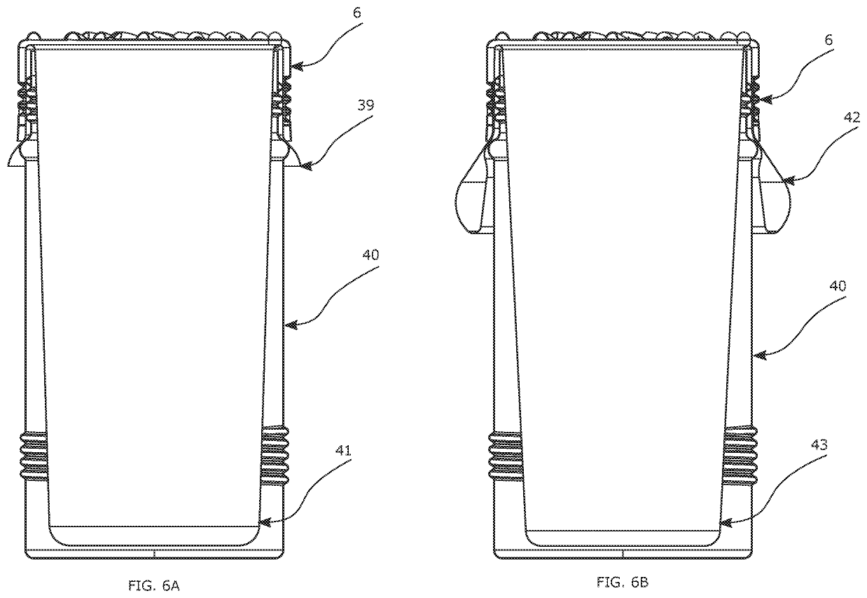

FIGS. 6A and 6B show different exemplary configurations for integrating a liner or bag into use with an exemplary preferred device embodiment. FIGS. 6A and 6B show cross-sectional views of a cylindrical sample container 40 (same as sample container 1 of FIGS. 1A and 1B, scaled down to illustrate the threading of a bag through the device for sanitary reasons) having a rim at the open end, threads and a lip, and having a cap/lid 6 mounted via complementary threads at the open end, and against the lip (same as lip 4 of FIGS. 1A and 1B). There is no coupler yet mounted at the closed end in the views shown. A sample bag 39 is positioned within the sample container 40. The bag 39 has a closed end 41 positioned near the closed inner end of the sample container 40, and an open end folded outwardly over the rim and extending through and between the engaged threads and between the seated lip on the outer surface of container 40. The bag 39 is thus positioned such that gathered sample only touches the inside surface of the bag 39 within the container 40, and kept sanitary (protected from external contamination) by virtue of being pinched by the sealed lip. FIG. 6B shows an alternative method/configuration for threading a bag 42 so that the inside surface 43 is better protected from exposure to the outside of the sampling container 40. Relative to the bag threading configuration of FIG. 6A, in FIG. 6B, after the bag is folded outwardly over the rim and extended through and between the engaged threads and between the seated lip on the outer surface of container 40, the open end of the bag is folded outwardly and upwardly through and between the engaged threads, such that upon removal of the sample containing bag 42 from the container 40 no internal surface of the bag 39 will have been contaminated from exposure to the outside of the sampling container 40 during the sampling procedure.

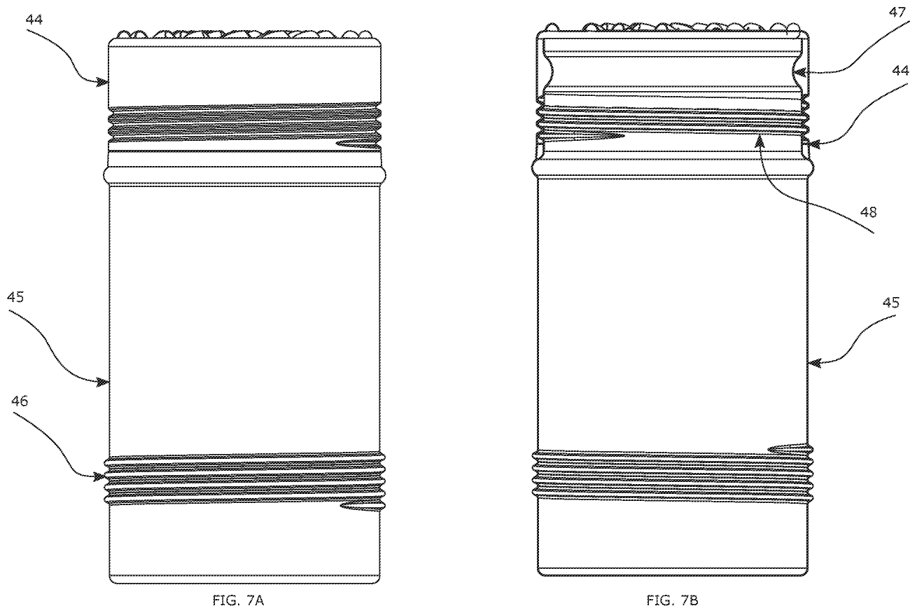

FIGS. 7A and 7B show an exemplary cylindrical sample container 45 attached, via complementary threads 48, to cylindrical sample gathering surface/lid 44 that is taller than the surface/lid 6 of FIG. 1A. As with the gathering container 1 of FIG. 1A, the gathering container 45 also has threads 46 extending from the outer surface of the container 45 and positioned/configured at a sufficient distance from the closed end to provide for attachment of a coupler (e.g., like the coupling member/device 12 of FIG. 1C), to enable use of an actuator (e.g., a robot or commercial drill, etc.) to actuate (e.g., rotate, turn, vibrate, oscillate, etc.) the sample gathering assembly (the assembled container 45 and sample gathering surface/lid 44). As shown in the cross-sectional view of FIG. 7B, the sample container 45 has a bag-mounting feature 47 (e.g., circumferential dip or groove feature) configured to provide for mounting a sample bag (not shown) by tying off the open end of the mounted bag within the bag-mounting feature 47 such that it is protected from contamination by the lid 44, and from exposure to the outside of the sampling container 45 during the sampling procedure. Additionally, note that the threads 48 are positioned below the bag-mounting feature 47 where the bag is tied off so that threading over the bag (as in the embodiments of FIGS. 6A and 6B) may be avoided.

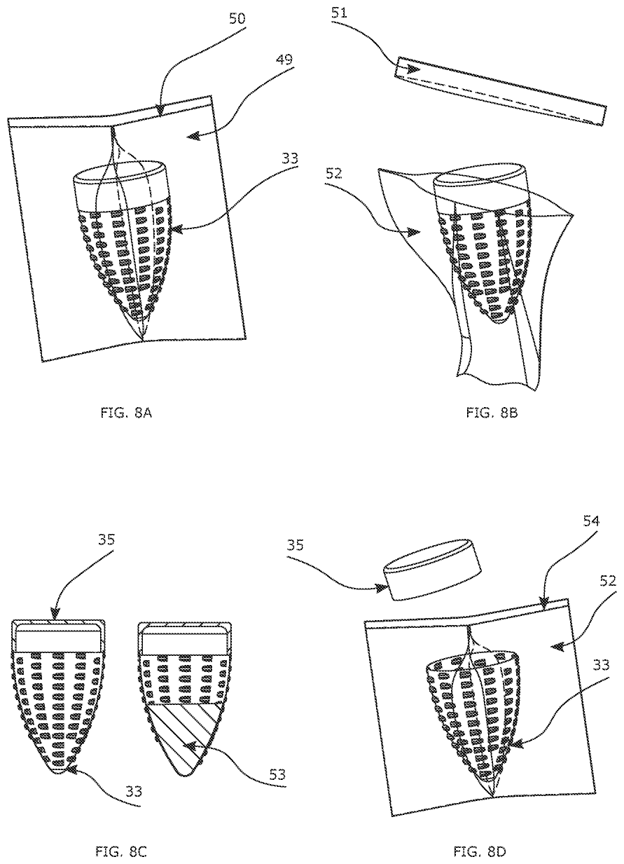

FIGS. 8A-8D shows an exemplary method by which the present device(s) can be supplied in a sanitary container (FIG. 8A), be removed (FIG. 8B), used to collect a sample (FIG. 8C) and re-sealed (FIG. 8D) for subsequent testing without any need to touch the sample gathering surface. More specifically, FIG. 8A shows the sample gathering surface 33 and attached coupler 35 of embodiment of FIG. 5A sealed in a sanitary bag 49 having a seam 50 that can be ripped/torn to open the bag 49. As shown in FIG. 8B, upon tearing the seam 50 a top bag portion 51 can be removed, and the opened bag 52 can be manipulated (e.g., scrunched up) from the outside to expose the attached coupler 35 through the opened end of the bag 49 so that it can be grasped to remove and manipulate the attached sample gathering surface 33 to gather (e.g., by actuating it using a robot, commercial drill, etc., not shown) a sample 53. FIG. 8D shows the sampling surface 33 containing a gathered sample 53 (not shown) placed in bag 52 with a seal 54, while the coupler 35 is detached and left outside because it may carry contamination from an operator's touch or from other source (e.g., actuator robot, drill, etc.) during gathering of the sample 53.

FIGS. 9A-9D show exemplary two-piece preferred device embodiments which could be used in the same manner as shown for the device illustrated in FIGS. 8A-8D to avoid contamination. More specifically, FIG. 9A shows a sample gathering assembly comprising (i) a combined sample gathering container 55 having in integrated sample gathering surface similar to that shown in FIG. 4, and (ii) a coupler 12 that is identical to the coupler 12 shown in FIGS. 2A and 2B that allows the use of an actuator (e.g., robot, commercial drill, etc.) to turn the sample gathering assembly. The coupler 12 is attached/mated to the combined sample gathering container 55 via complementary threads 56. In this embodiment, combined sample gathering container 55 has an open end 57 opposite the sample gathering surface, such that the coupler 12 serves as a lid and can be removed by unscrewing the combined sample gathering container 55 from the coupler 12.

In FIGS. 9C and 9D, the combined sample gathering container 55 is identical to that shown in FIGS. 9A and 9B, but the coupler 58, attached via complementary threads 59, is lengthened/taller relative to, e.g., the coupler 12 of FIGS. 9A and 9B, to provide an extended coupler surface that encloses at least a portion of the collecting container surface of the combined sample gathering container 55, and configured such that a user could brace against the extended surface while taking a sample, without contaminating the surfaces of the of the combined sample gathering container 55. As in the embodiment of FIGS. 9A and 9B, the combined sample gathering container 55 has an open end opposite the sample gathering surface, such that the coupler 58 serves as a lid and can be removed by unscrewing the combined sample gathering container 55 from the coupler 58. As in the case of the coupler 12 embodiment of FIGS. 2A and 2B, the inside diameter of the coupler 58 between its closed end and threads 59 provides for a tight fit radially that provides stability for the combined sample gathering container 55. While not shown in FIGS. 9C and 9D, as in other coupler embodiments, the coupler 58 may have a shaft or the like, extending (e.g., axially) from its outer surface to facilitate coupling to an actuator. Additionally, while not shown in FIGS. 9C and 9D, and as in other coupler embodiments, the coupler 58 may be configured with attachment elements other than threads (e.g., tabs, clips, snap-fits, etc.) that communicate with complementary elements on the surface of the combined sample gathering container 55 to provide for mounting/mating with the coupler 58.

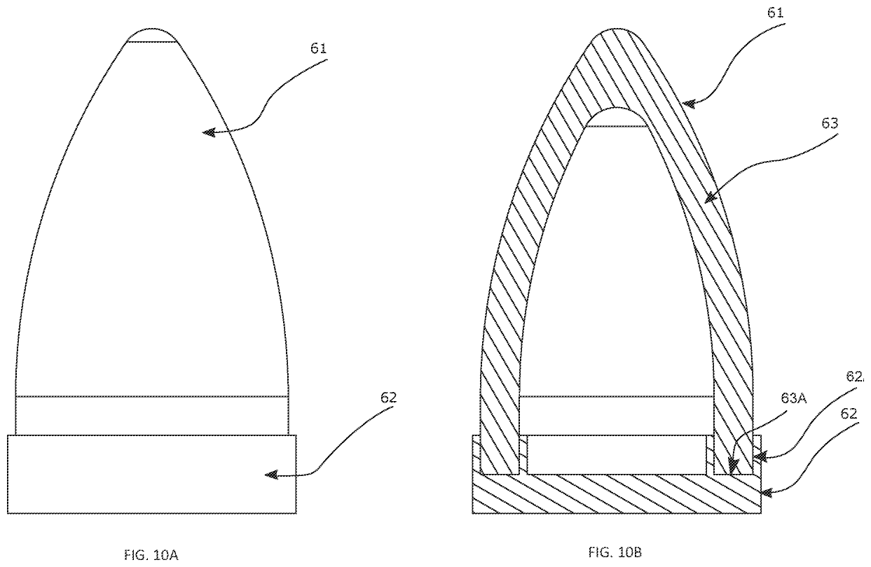

FIGS. 10A and 10B show an alternative embodiment of a non-flat and non-developable combined sample gathering container 61 attached to a coupler 62. In this embodiment, the entire sample gathering surface 63 of the combined sample gathering container 61, or a substantial portion thereof, comprises or is made from a porous, abrasive material that provides for initial sampling and sample particle capture on the sample gathering surface, and subsequent passage of the captured particles into the interior collecting chamber of the device. The porous, abrasive material may be of any suitable thickness and may be of any suitable abrasive, porous material (e.g., abrasive sponge material, porous metallic material (e.g., steel wool, etc.), silicon carbide-based materials, etc.) as long as the sampling surface provides for passage of sampled material through the sampling surface to the inner containment space/chamber of the device. As in the embodiments of FIGS. 9A-9D, the combined sample gathering container 61 has an open end, such that the coupler 62 serves as a lid and can be removed by unscrewing the combined sample gathering container 61 from the coupler 62. In this embodiment, the coupler 62 is mounted/mated to the combined sample gathering container 61 using an annular groove 62A in the wall of the cylindrical coupler 62 that is configured to reversibly receive the complementary annular open end 63A of the combined sample gathering container 61. The width and depth of the groove 62A is configured to provide for a tight fit that provides stability for the combined sample gathering container 61. While not shown in FIGS. 10A and 10C, and as in other coupler embodiments, the coupler 62 may have a shaft or the like, extending (e.g., axially) from its outer surface to facilitate coupling to an actuator. Additionally, while not shown in 10A and 10C, as in other coupler embodiments, the coupler 62 may be configured with attachment elements other than an annular groove (e.g., threads. tabs, clips, snap-fits, etc.) that communicate with complementary elements on the surface of the combined sample gathering container 61 to provide for mounting/mating with the coupler 62.

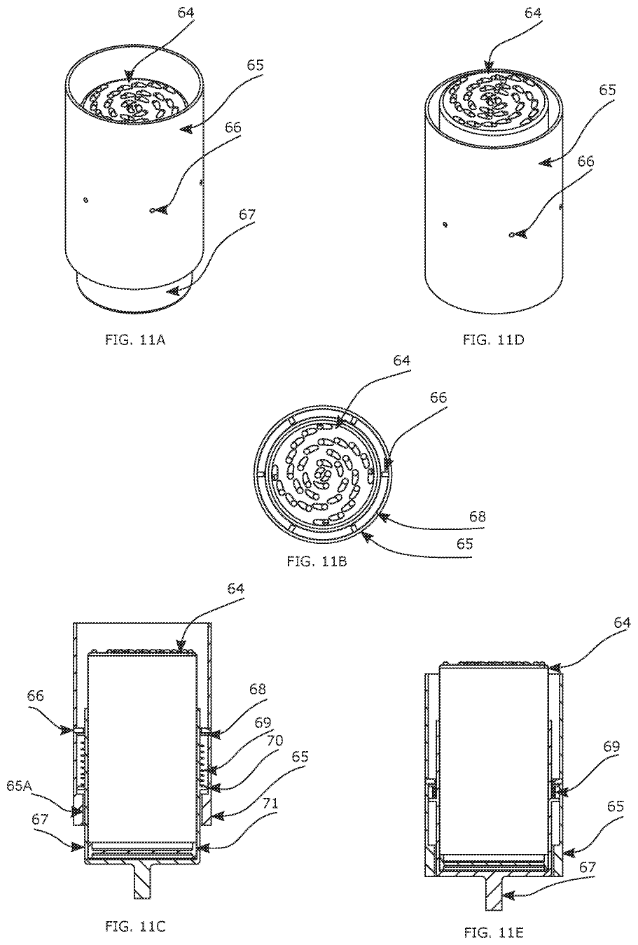

FIGS. 11A-11E show an alternative cylindrical combined sample gathering container 64 having an integrated sample gathering surface, and attached to a cylindrical coupler 67 having an open end and a closed end. This embodiment has a retractable external sheath 65 that extends beyond the sample gathering surface when the device is not in use, and is configured to be pressed back upon contact of the sheath 65 with a sample surface and/or be pulled back by a user to take a sample. Similar to the coupler 58 of FIGS. 9C and 9D, the cylindrical walls of the coupler 67 in this embodiment are lengthened/taller (relative to, e.g., the coupler 12 of FIGS. 9A and 9B), to provide an extended cylindrical coupler surface to protect combined sample gathering container 64. There is a (e.g., circumferential) flange 70, extending (e.g., normally) on the outside of the extended coupler surface. As shown in the FIGS. 11A and 11C, a cylindrical retractable sheath 65, open at both ends and having inner diameters larger than the external diameter of the extended walls of the cylindrical coupler 67, extends, in a non-retracted state, around and along the extended cylindrical coupler surface to a position beyond the sample gathering surface of the combined sample gathering container 64 to further protect the sample gathering surface from accidental contact. As shown in the cross-sections of FIGS. 11C and 11E, the retractable sheath 65 has an annular step region 65A at one end having an inner diameter less than that of the remainder of sheath 65, and as shown in, e.g., FIG. 11B, a (e.g., circumferential) array of dowel pins 66, each extending (e.g., radially) from the inner surface of the sheath 65, is positioned at a distance from the step 65A along the inner surface of the sheath 65. One or more compression spring(s) 69 is/are positioned between the flange 70 and the circumferential array of dowel pins 66, and a retaining ring 68 positioned between the spring(s) 69 and the array of dowel pins 66 to retain the spring(s) 69 between the retaining ring 68 and the flange 70. In the normal, non-retracted state (FIGS. 11A and 11C), spring pressure holds the annular step region 65A against the flange 70, and the sheath 65 extends beyond the sample gathering surface of the combined sample gathering container 64. In a retracted state, as shown in FIGS. 11D and 11E, the sheath 65 is pushed toward the closed end of the coupler 67, compressing the spring(s) 69 between the retaining ring 68 and the flange 70, and sufficiently exposing the sample gathering surface of the combined sample gathering container 64 so that a sample may be obtained, but where the combined sample gathering container 64 is otherwise protected from contamination. The retractable sheath 65 may be retracted by an operator or by pressure against a material to be sampled during sampling. In this embodiment, the combined sample gathering container 64 is sealed at its open end by a removable plug 71 positioned between the open end and the inner closed end of the coupler 67, defining a sample containing area/chamber within the combined sample gathering container 64. Plug 71 may be configured to be removable with the combined sample gathering container 64, when it is detached from the coupler 67, or may be configured to remain with the coupler 67 when the combined sample gathering container 64 is detached therefrom.

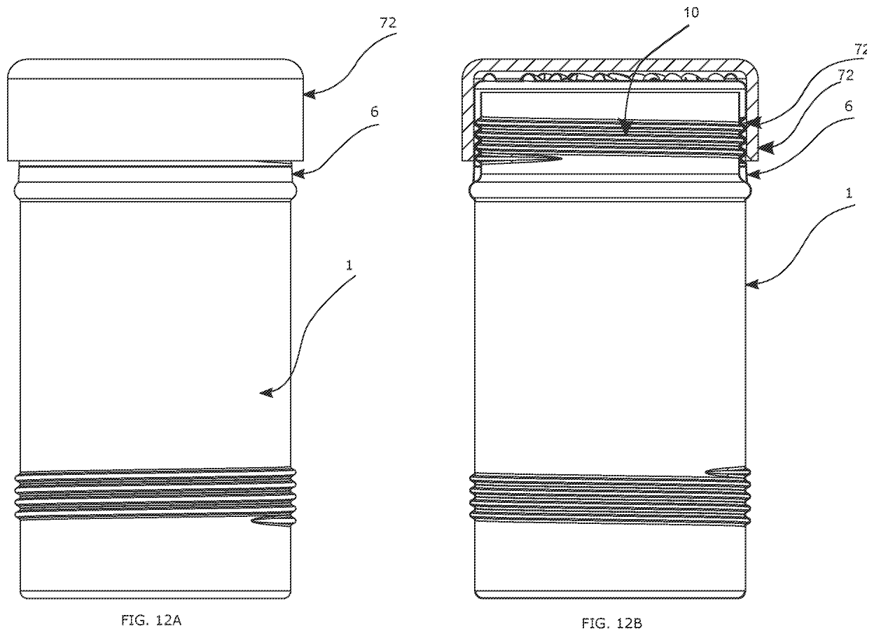

FIGS. 12A and 12B show the preferred embodiment of a sample containing and gathering device as shown in FIGS. 1A and 1B having identical container 1 and sample gathering surface/lid 6, but further comprising a sanitary lid 72 with threads 72A extending from its inner surface. Threads 72A are complementary to threads 10 on sample gathering surface/lid 6, to provide for mounting/mating the sanitary lid 72 over the sample gathering surface/lid 6 after sampling to maintain sample integrity. Such sanitary lids are options for any of the sample containing and gathering device of the present invention, and may be attached/mounted/mated by any suitable means (e.g., threads, tabs, clips, snap-fits, etc.). While not shown in FIGS. 12A and 12B, and as in other embodiments disclosed herein, a coupler, e.g., similar to the coupler 12 of FIGS. 2A and 2B, may be attached to the device (e.g., by mounting/mating with the threads near the other of container 1), to provide for actuating the device for sample gathering.

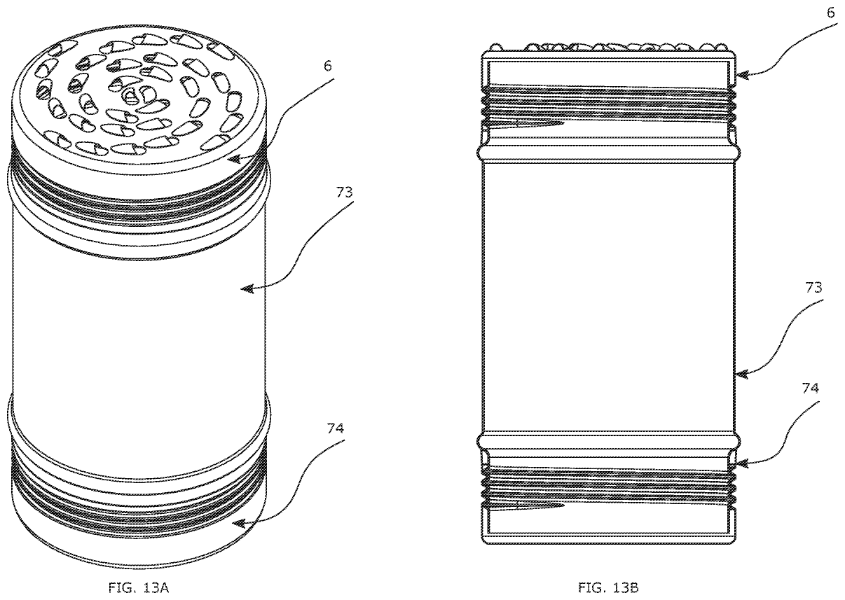

FIGS. 13A and 13B show an exemplary sample containing and gathering device embodiment where the sample container portion 73 of the sample containing and gathering device is made up of a cylindrical tube having threads at both open ends. There is a sample gathering surface/lid 6 at one end, and a bottom lid 74 at the other end, both lids being attached in this embodiment via complementary threads. The bottom lid 74 can be unscrewed to remove a gathered sample. While not shown in FIGS. 13A and 13B, and as in other embodiments disclosed herein, this embodiment may further comprise a sanitary lid, e.g., similar to the sanitary lid 72 shown in FIG. 12B. Likewise, a coupler, e.g., similar to the coupler 12 of FIGS. 2A and 2B, may be attached to the device (e.g., by mounting/mating with the threads of the bottom lid 74), to provide for actuating the device for sample gathering.

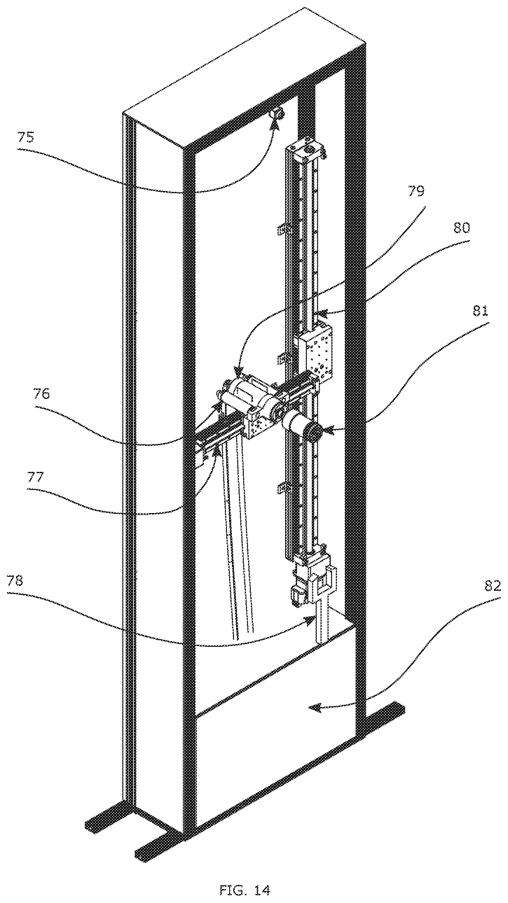

FIG. 14 shows an exemplary robotic gantry and coupling mechanism that may be used to automate the sample taking process on an assembly line. In this embodiment, the preferred embodiment of FIGS. 1A and 2B is coupled onto a spindle of the robotic gantry. A camera 75 mounted at a position suitable to monitor bulk material passing on an assembly line/conveyor line is configured as part of an automated vision system (not shown) for instructing the robotic gantry where to take samples from. Air cylinders 76 control the x-axis of the robotic gantry, and lead screws 77 control the y-axis of the robotic gantry. An automated mechanism 78 is configured to remove a full sample containing and gathering device as disclosed herein, and retrieve and mount an empty one from a stock source to fully automate the process. A pneumatic spindle 79 actuates the sampling device. Lead screws 80 control the z-axis of the robotic gantry. In this FIG. 14, the sample containing and gathering device 81 is the same as that illustrated in FIGS. 1A and 2B. A container 82 for, e.g., control electronics, air compressor, etc., is also shown.

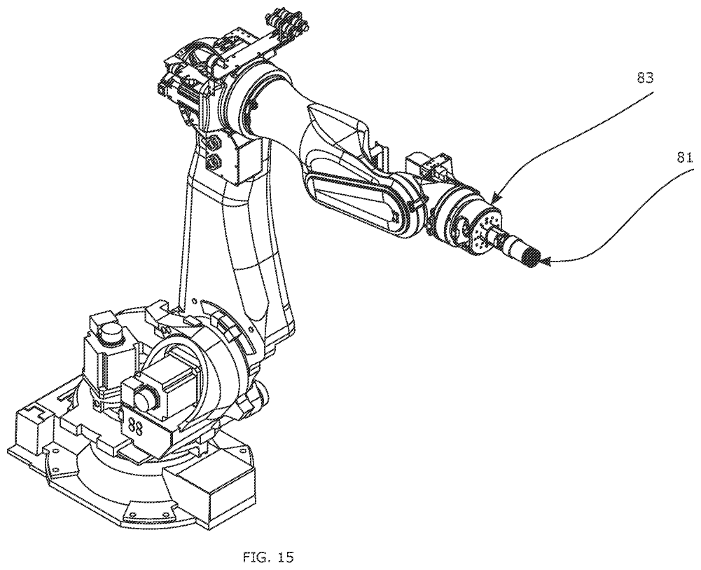

FIG. 15 shows a sample containing and gathering device 81, which is the same as the exemplary preferred embodiment illustrated in FIGS. 1A and 2B, assembled onto a commercial robot to automate the sampling process. The spindle 83 of a commercial robotic arm is shown in actuating communication with the sample containing and gathering device 81.

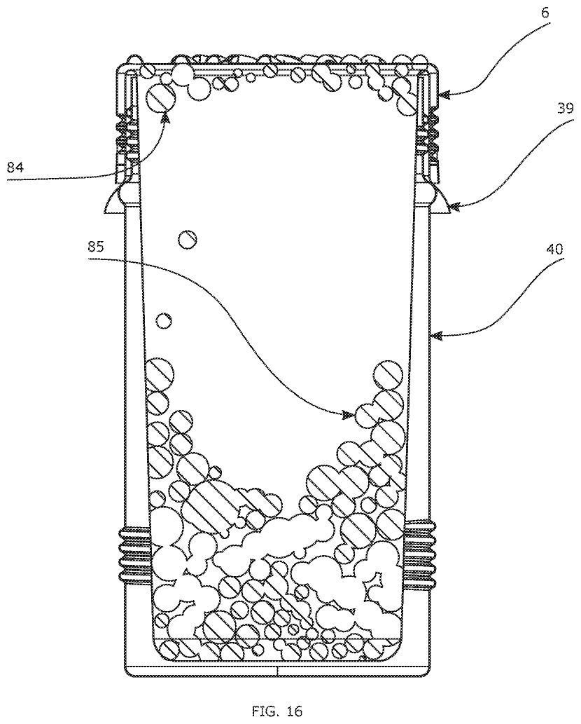

FIG. 16 shows the exemplary sample containing and gathering device, which is the same as that of the exemplary preferred embodiment illustrated in FIGS. 1A and 2B and in FIG. 6A, and shown here with a sample material 84 inside. There is a sample gathering surface/lid 6 attached to the sample container 40 via engaged complementary threads. A sample bag 39 is positioned within the sample container 40. The bag 39 has a closed end 41 positioned near the closed inner end of the sample container 40, and an open end folded outwardly over the rim and extending through and between the engaged threads and between the seated lip on the outer surface of container 40. The bag 39 is thus positioned such that the gathered sample 84 only touches the inside surface of the bag 39 within the container 40, and kept sanitary (protected from external contamination) by virtue of being pinched by the sealed lip. Sample material 84 may stick to the inner sample gathering surface of the gathering surface/lid 6 (e.g., if the sample material 84 is moist), but the sample material 85 falls to the bottom inner surface of the bag 39 when the container 40 is upright. Rotation of the container 40 during sampling may tend to radially distribute the sample material 85 towards the inner cylindrical wall of the container 40. While not shown in FIG. 16, and as in other embodiments disclosed herein, this embodiment may further comprise a sanitary lid, e.g., similar to the sanitary lid 72 shown in FIG. 12B. Likewise, a coupler, e.g., similar to the coupler 12 of FIGS. 2A and 2B, may be attached to the device (e.g., by mounting/mating with the threads near the bottom of container 40), to provide for actuating the device for sample gathering.

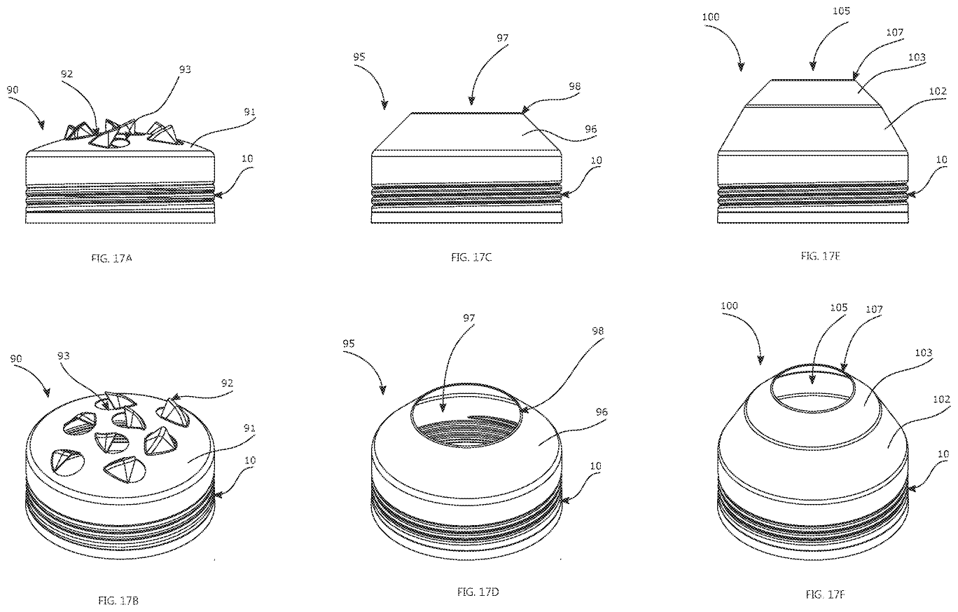

FIGS. 17A-17F show exemplary alternative options for the sample gathering surface of lids that can be assembled, for example, onto sample gathering canisters/containers disclosed herein, including onto the preferred embodiment illustrated in FIGS. 1A and 2B in place of the component illustrated in FIG. 1B, to provide sample gathering device(s).

FIGS. 17A and 17B show side and isometric views, respectively, of a lid 90 with a slightly domed surface 91 having an array of pointy teeth, e.g., raised (e.g., angularly raised) triangular (e.g., inverted sloping V-shaped) protrusions 92 configured with a respective array of apertures (e.g., orifice/hole) 93 through the slightly domed surface 91 configured to direct sampled material into the sample container. The protrusions 92 are configured to bite into or puncture the surface of the material being sampled, and funnel the sampled material into the sample gathering canister of the sampling device, allowing for easier sample collection. The lid 90 has threads 10, positioned between the sample gathering surface 91 and the open end of the lid 90, which threads 10 are complementary to threads of a sample gathering container to provide for reversibly assembling/attaching the sample gathering surface/lid 90 to a sample gathering container, and for removal of the lid 90 for sample extraction from the sample gathering container. In additional embodiments, the surface 91 may be beveled (flat angular) rather than domed, or may be any other suitable shape that extends outwardly to facilitate accessing tighter/more confined areas of the material to be sampled.

FIGS. 17C and 17D show side and isometric views, respectively, of a lid 95 with a raised, beveled sampling surface 96 having a simple circular sampling hole 97 at the top (e.g., a centered, 1-inch (2.54 cm) hole, or any other suitable hole diameter). The circular edge/blade 98 defining the hole may be configured to function as a blade and may be sharpened (or otherwise configured to cut). In operation of sampling devices comprising lid 95, the lid 95 and sampling surface 96 with its circular blade 98 is rotating/spinning and is contacted with/scraped along the material to be sampled. The motion of the spinning circular blade 98 allows it to function in the manner of drawing a knife across/through the material to be sampled (aiding in breaking the surface and cutting it, e.g., in the manner of cutting the skin of a tomato), and the cut sample pieces are funneled into the interior of the sample gathering canisters/containers (e.g., 1 of FIG. 1 and 2; or 40 of FIG. 6) of the sampling device. The lid 95 has threads 10, positioned between the sample gathering surface 96 and the open end of the lid 95, which threads 10 are complementary to threads of a sample gathering container (e.g., 1 of FIG. 1 and 2; or 40 of FIG. 6) to provide for reversibly assembling/attaching the sample gathering surface/lid 95 to a sample gathering container (e.g., 1 of FIG. 1 and 2; or 40 of FIG. 6), and for removal of the lid 95 for sample extraction from the sample gathering container. In additional embodiments, the surface 96 may be dome shaped rather than beveled (flat angular), or may be any other suitable shape that extends outwardly to facilitate accessing tighter/more confined areas of the material to be sampled.

FIG. 17E and 17F show side and isometric views, respectively, of a lid 100 with a raised, sampling surface having two beveled surface portions 102 and 103, each at a different angle with respect to the lid axis, and having a simple circular sampling hole 105 at the top (e.g., in this embodiment the hole 105 is somewhat smaller than hole 97 of FIGS. 17C and 17D, or may be any other suitable hole diameter). The circular edge/blade 107 defining the hole may be configured to function as a blade and may be sharpened (or otherwise configured to cut). In operation of sampling devices comprising lid 100, the lid 100 and sampling surfaces 102 and 103 with its circular blade 107 is rotating/spinning and is contacted with/scraped along the material to be sampled. The motion of the spinning circular blade 98 allows it to function in the manner of drawing a knife across/through the material to be sampled (aiding in breaking the surface and cutting it), and the cut sample pieces are funneled into the interior of the sample gathering canisters/containers (e.g., 1 of FIG. 1 and 2; or 40 of FIG. 6) of the sampling device. The shape of cap 100 comprising a relatively smaller hole (e.g., less than 1 inch diameter) and two differently angled beveled surfaces 102 and 103 allows a user to collect samples in tighter (e.g., more confined, limited access) areas of the material to be sampled. As in other embodiments described herein, the lid 100 has threads 10, positioned between the sample gathering surface 102 and the open end of the lid 100, which threads 10 are complementary to threads of a sample gathering container (e.g., 1 of FIG. 1 and 2; or 40 of FIG. 6) to provide for reversibly assembling/attaching the sample gathering surface/lid 100 to a sample gathering container (e.g., 1 of FIG. 1 and 2; or 40 of FIG. 6), and for removal of the lid 100 for sample extraction from the sample gathering container. In additional embodiments, the surface portions 102 and 103 may be dome shaped rather than beveled (flat angular), or may be any other suitable shape that extends outwardly to facilitate accessing tighter/more confined areas of the material to be sampled.

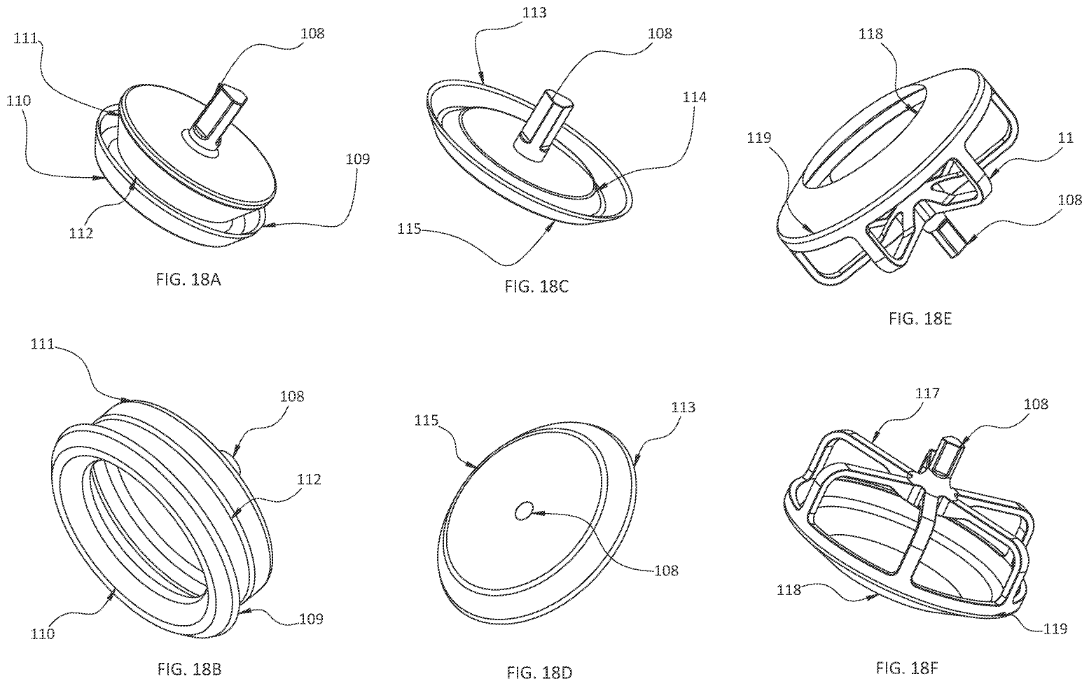

FIGS. 18A-18F show exemplary additional sample gathering device embodiments.

FIGS. 18A and 18B show respective back and front isometric views of one such embodiment having a back portion 111 with extension 108 (e.g., hex rod extension) for mounting (e.g., clamping) in a spinning device, and having a front surface portion 110 with an open pocket (to reduce weight) and an outer sharp blade edge 109 disposed at a rearward angle relative to the extension axis for cutting through material while scraping along a surface at an angle while spinning. A gap withsample gathering surface 112 between the blade and back portion creates the sample cut size (e.g., controls thickness) when cutting through a material. The front 110 and back 111 portions may be integral or joined (e.g., reversibly attached). The extension 108 may be integral or joined (e.g., reversibly attached) to the front 110 and back 111 portions. The embodiment of FIGS. 18A and 18B may, for example, be used as a lightweight, useful alternative to devices such as those of FIGS. 17E and 17F, which are designed to attach to sample containers.

FIGS. 18C and 18D show respective back and front isometric views of another such embodiment having a rear extension 108 (e.g., hex rod extension) for mounting (e.g., clamping) in a spinning device, and having a front sample gathering surface portion 115 with an outer sharp blade edge 113 disposed at a rearward angle relative to the extension axis for cutting through material while scraping along a surface at an angle while spinning, and with an inner portion configured to provide a gap with sample gathering surface 114 between the blade edge and the inner portion to create the sample cut size (e.g., controls thickness) when cutting through a material. The front portion 115 and the rear extension 108 may be integral or joined (e.g., reversibly attached). The embodiment of FIGS. 18C and 18D may, for example, be used as a lightweight, useful alternative to devices such as those of FIGS. 17E and 17F, which are designed to attach to sample container.

FIGS. 18E and 18F show respective front and back isometric views of another such embodiment having a rear extension 108 (e.g., hex rod extension) for mounting (e.g., clamping) in a spinning device, and having a raised (e.g., beveled, domed, etc.) front sample gathering surface portion 119 with a simple circular sampling hole at the top (e.g., a centered, 1-inch (2.54 cm) hole, or any other suitable hole diameter) with a circular edge/blade 118 defining the hole for cutting through material while scraping along a surface (e.g., at an angle) while spinning (to function as a blade that may be sharpened (or otherwise configured to cut). Flange 117, in this instance comprising multiple (e.g., 6) spaced connecting arms, connects the front sample gathering surface portion 119 and the rear extension 108. The motion of the spinning circular blade 118 allows it to function in the manner of drawing a knife across/through the material to be sampled (aiding in breaking the surface and cutting it, e.g., in the manner of cutting the skin of a tomato), and the cut sample pieces are funneled toward the flange (e.g., toward the spaced flange arms). In additional embodiments, the surface 119 may be dome-shaped rather than beveled (one or more flat angular surfaces), or may be any other suitable shape that extends outwardly (forward) to facilitate accessing tighter/more confined areas of the material to be sampled. The embodiment of FIGS. 18E and 18F may, for example, be used as a lightweight, useful alternative to devices such as those of FIGS. 17C and 17D, which are designed to attach to sample container.

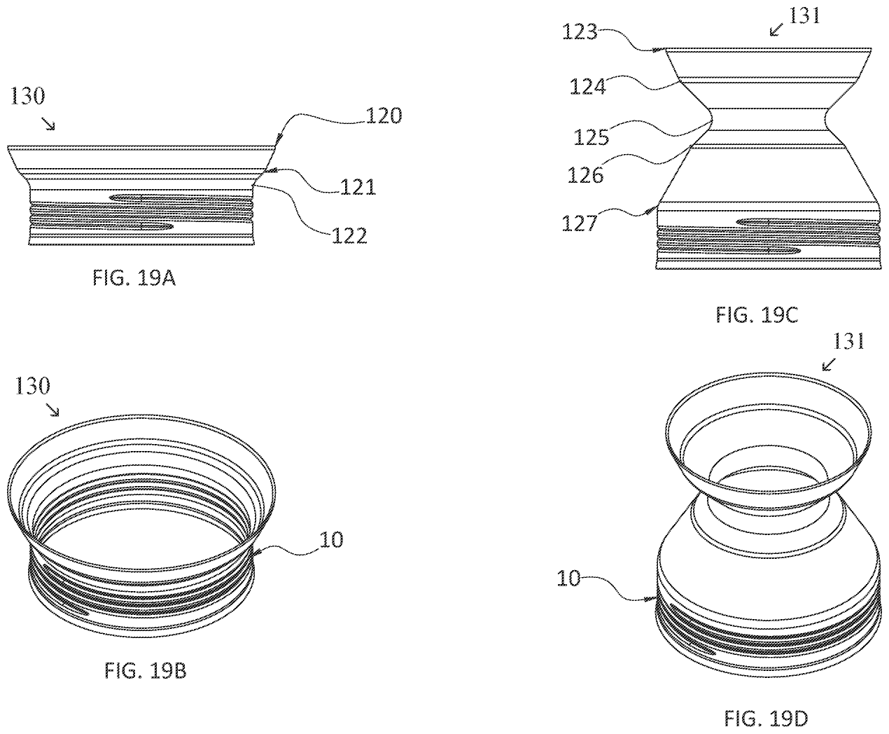

FIGS. 19A-19D show exemplary additional sample containing and gathering device embodiments.

FIGS. 19A and 19B show respective side and front isometric views of one such push to cut embodiment having a circular lid 130 having lower open end, and having an upper raised angled sampling surface 121 and 122 extending outwardly from the lid axis to a sharp outer edge circular cutting blade 120 (defining a circular hole) for cutting through material while scraping along a surface (e.g., at an angle) while spinning (to function as a blade that may be sharpened (or otherwise configured to cut). The cut sample pieces are funneled through the lower open end into the interior of sample a gathering canister/container (e.g., 1 of FIG. 1 and 2; or 40 of FIG. 6) of the sampling device. The lid 130 has threads 10, positioned between the circular cutting blade 120 and the lower open end, which threads 10 are complementary to threads of a sample gathering container (e.g., 1 of FIG. 1 and 2; or 40 of FIG. 6) to provide for reversibly assembling/attaching the sample gathering surface/lid 130 to a sample gathering container (e.g., 1 of FIG. 1 and 2; or 40 of FIG. 6), and for removal of the lid 95 for sample extraction from the sample gathering container. In additional embodiments, the raised sampling surface may be dome shaped rather than beveled (flat angular), or may be any other suitable shape that extends outwardly from the lid axis to facilitate accessing areas of the material to be sampled.

FIGS. 19C and 19D show respective side and front isometric views of another such push to cut embodiment having a circular lid 131 having lower open end, and having an upper raised angled sampling surface with a first surface portion 126 and 127 extending inwardly (e.g., angled) toward the lid axis, and with a neck portion 125 connecting the first surface portion with a second surface portion 124 extending outwardly from the neck portion 125 to a sharp outer edge circular cutting blade 123 (defining a circular hole) for cutting through material while scraping along a surface (e.g., at an angle) while spinning (to function as a blade that may be sharpened (or otherwise configured to cut). The cut sample pieces are funneled through the neck portion 125 and lower open end into the interior of a sample gathering canister/container (e.g., 1 of FIG. 1-2; or 40 of FIGS. 6) of the sampling device. The lid 131 has threads 10, positioned between the neck portion 125 and the lower open end, which threads 10 are complementary to threads of a sample gathering container (e.g., 1 of FIG. 1 and 2; or 40 of FIG. 6) to provide for reversibly assembling/attaching the sample gathering surface/lid 131 to a sample gathering container (e.g., 1 of FIG. 1 and 2; or 40 of FIG. 6), and for removal of the lid 131 for sample extraction from the sample gathering container. The first inwardly extending surface portion 126 and 127 along with the neck portion 125 tend to trap sampled material inside the sample container. In additional embodiments, the raised portions of the sampling surface on either or both sides of the neck portion 125 may be dome shaped rather than beveled (flat angular), or may be any other suitable shape that extends inwardly and then outwardly from the lid axis to facilitate accessing areas of the material to be sampled, and/or to facilitate retention of sampled material in a sample gathering container.

The foregoing embodiments are intended to illustrate preferred embodiments of the claimed invention, and do not limit the intended scope.

Disclosed are exemplary components that can be used to perform the disclosed devices and methods, and it is understood that when combinations, subsets, interactions, groups, etc. of these components are disclosed that while specific reference of each various individual and collective combinations and permutations of these may not be explicitly disclosed, each is specifically contemplated and described herein, for all devices and methods. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

What is claimed is:

1. A sample containing and gathering device, comprising:
a sample gathering end portion having a wall with an inner surface and an outer sample gathering surface with one or more apertures communicating therebetween;
a coupling end portion having a wall with an inner surface and an outer coupler surface; and
a sample canister having a wall with inner and outer wall surfaces extending between and connecting with the end portions along a central axis, wherein the inner canister wall surface, and the inner surfaces of the sample gathering end portion or of the coupling end portion, or both define an inner sample-containing space, and wherein the sample gathering end portion, the coupling end portion, or both are configured to be reversibly detachable from the sample canister to provide a respective first sample canister open end, a second sample canister open end, or both, to provide access to the sample containing space.

2. The device of claim 1, wherein the coupling end portion is integral with the sample canister, and not reversibly detachable.

3. The device of claim 1, wherein the sample gathering end portion is integral with the sample canister, and not reversibly detachable.

4. The device of claim 1, wherein the sample gathering end portion is reversibly detachable and comprises a cylindrical cap having an open end defined by an open-end lip, an end having the sample gathering surface, and first threads configured in the wall between the sample gathering surface and the open-end lip and engageable on the inner surface of the sample gathering end portion, wherein the sample canister is cylindrical having a first open end defined by a first rim, and second threads complementary to the first threads and configured in the canister wall between the first rim and a sealing lip positioned on the outer canister wall surface to provide a seat for the open-end lip of the sample gathering end portion when attached to the sample canister.

5. The device of claim 2, wherein the sample gathering end portion is reversibly detachable and comprises a cylindrical cap having an open end defined by an open-end lip, an end having the sample gathering surface, and first threads configured in the wall between the sample gathering surface and the open-end lip and engageable on the inner surface of the sample gathering end portion, wherein the sample canister is cylindrical having a first open end defined by a first rim, and second threads complementary to the first threads and configured in the canister wall between the first rim and a sealing lip positioned on the outer canister wall surface to provide a seat for the open-end lip of the sample gathering end portion when attached to the sample canister.

6. The device of claim 1, wherein the coupling end portion is reversibly detachable and comprises a cylindrical cap having a closed end, an open end, and third threads (or first attachment members) configured therebetween in the coupling end wall and engageable on the inner surface of the coupling end portion, and wherein the sample canister has fourth threads (or second attachment members) complementary to the third threads (or first attachment members) and configured on the canister wall, and engageable on the outer canister wall surface, at a distance from the second open end sufficient to provide for reversible attachment of the coupling end portion.

7. The device of claim 3, wherein the coupling end portion is reversibly detachable and comprises a cylindrical cap having a closed end, an open end, and third threads (or first attachment members) configured therebetween in the coupling end wall and engageable on the inner surface of the coupling end portion, and wherein the sample canister has fourth threads (or second attachment members) complementary to the third threads (or first attachment members) and configured on the canister wall, and engageable on the outer canister wall surface, at a distance from the second open end sufficient to provide for reversible attachment of the coupling end portion.

8. The device of claim 4, wherein the sample canister has the first and the second sample canister open ends, and wherein both the sample gathering end portion and the coupling end portion are configured to be reversibly detachable from the sample canister.

9. The device of claim 6, wherein the sample canister has the first and the second sample canister open ends, and wherein both the sample gathering end portion and the coupling end portion are configured to be reversibly detachable from the sample canister.

10. The device of claim 1, wherein the coupling end portion is configured to provide a mechanical coupling between an actuator device and the coupling end portion.

11. The device of claim 2, further comprising a coupler member configured to provide a mechanical coupling between an actuator device and the integral coupling end portion.

12. The device of claim 11, wherein the coupler member comprises a cylindrical cap having a wall with inner and outer surfaces, a closed end, an open end, and coupler threads (or first attachment members) configured in the wall between the closed and the open ends and engageable on the inner surface of the coupler member, and wherein the sample canister has canister threads (or second attachment members) complementary to the coupler threads (or first attachment members) and configured and engageable on the outer canister wall surface to provide for reversible attachment of the coupler member.

13. The device of claim 4, wherein both the rim and the sealing lip of the sample canister provide seats when the sample gathering end portion is attached to the sample canister.

14. The device of any one of claims 1-13, further comprising a bag or other lining container or material.

15. The device of any one of claims 1-14, wherein the sample gathering surface is flat or outwardly raised, and wherein the one or more apertures in each case comprises a respective cutting protrusion extending outwardly from the sample gathering surface and configured, in operation of the device, to cut and direct sampled material to the inside of the sample containing and gathering device.

16. The device of any one of claims 1-14, wherein the sample gathering surface is flat or outwardly raised, and wherein the one or more apertures in each case comprises one or more respective circular edges or blades defining one or more respective circular sampling holes and configured, in operation of the device, to cut and direct sampled material to the inside of the sample containing and gathering device.

17. The device of claim 16, wherein the sample gathering surface of the sample gathering end portion is outwardly raised, and comprises a single sampling aperture defining a circular cutting edge or blade.

18. The device of claim 17, wherein the sample gathering surface is beveled or domed, the single circular sampling aperture being centered around the central axis.

19. The device of claim 18, wherein the sample gathering surface comprises two or more beveled surface portions, each at a different angle with respect to the central axis.

20. A sample gathering device, comprising:
a rear mounting portion 108 defining an extension axis;
an axially aligned front sample cutting portion 115 having an outer circular blade edge 113 disposed outwardly at a rearward angle relative to the extension axis, and an inner sample gathering surface 114 having an inner margin defining a sample sizing gap between the blade edge and the inner margin on the lower surface, the front sample cutting portion being integral or non-integral with the rear mounting portion.

21. A sample gathering device, comprising:
a rear mounting portion 108 defining an extension axis;
an axially aligned front sample cutting portion 110, having, an outer circular blade edge 109 disposed outwardly at a rearward angle relative to the extension axis; and
an axially alighted back sample gathering portion, positioned between the rear mounting portion and the front sample cutting portion, having a sample gathering surface 112 with a rear margin defining a sample sizing gap between the blade edge and the rear margin, the back sample gathering portion being integral or non-integral with the rear mounting portion and/or the front sample cutting portion.

22. A sample gathering device, comprising:
a rear mounting portion 108 defining an extension axis;
an axially aligned front, sample gathering surface portion 119 having a wall with an inner surface and a raised outer sample gathering surface having a single sampling aperture communicating therebetween and defining a circular cutting edge or blade 118; and
an axially aligned flange 117 having a plurality of spaced connecting arms connecting the front sample gathering surface portion and the rear mounting portion 108, the flange being integral or non-integral with the rear mounting portion and/or the front, sample gathering surface portion.

23. A push to cut sample containing and gathering device, comprising:
a sample gathering circular end portion 130 having a lower open end, and having an upper raised angled sampling surface 121 and 122 extending outwardly from a central axis to a sharp outer edge circular cutting blade 120;
a coupling end portion having a wall with an inner surface and an outer coupler surface; and
a sample canister having a wall with inner and outer wall surfaces extending between and connecting with the end portions along the central axis, wherein the inner canister wall surface, and the inner surfaces of the sample gathering end portion or of the coupling end portion, or both define an inner sample-containing space, and wherein the sample gathering end portion, the coupling end portion, or both are configured to be reversibly detachable from the sample canister to provide a respective first sample canister open end, a second sample canister open end, or both, to provide access to the sample containing space.

24. The push to cut device of claim 23, wherein the sample gathering circular end portion comprises a neck portion 125 extending inwardly toward the central axis between the lower open end and the upper raised angled sampling surface.
